(19) United States
(12) Patent Application Publication
(10) Pub. No.: US 2026/0321208 A1
(43) Pub. Date: Oct. 15, 2026

(54) PIXEL DRIVE CIRCUIT AND DISPLAY PANEL

(71) Applicant: HKC CORPORATION LIMITED, Shenzhen, Guangdong (CN)

(72) Inventors: Zhiwei Ye, Shenzhen, Guangdong (CN); Xiufeng Zhou, Shenzhen, Guangdong (CN); Baohong Kang, Shenzhen, Guangdong (CN)

(21) Appl. No.: 19/475,068

(22) PCT Filed: Oct. 28, 2023
(86) PCT No.: PCT/CN2023/127422

§ 371 Date: Oct. 14, 2025

(30) Foreign Application Priority Data
Apr. 21, 2023 (CN) 202310431200.1

(51) Int. Cl. G09G 3/3233

(52) U.S. Cl. CPC G09G 3/3233; G09G 2300/043; G09G 2300/0819; G09G 2300/0842; G09G 2310/08; G09G 2320/0233; G09G 2320/045

(57) ABSTRACT

A pixel driving circuit and a display panel. The pixel driving circuit includes: a luminescence control circuit, a data input circuit, a compensation circuit, an energy storage circuit, a reset circuit, a first switch circuit, a second switch circuit, and a third switch circuit. An input of the luminescence control circuit is electrically connected to a first power supply through the first switch circuit, and an output of the luminescence control circuit is electrically connected to an anode of the luminescent device through the second switch circuit. An input of the compensation circuit is electrically connected to an input of the luminescence control circuit, and is electrically connected to a first end of the energy storage circuit through the third switch circuit; an output of the compensation circuit is electrically connected to an output of the data input circuit.

### CROSS-REFERENCE TO RELATED APPLICATIONS

This application claims priority to Chinese patent application No. 202310431200.1, filed on Apr. 21, 2023, and entitled “pixel drive circuit and display panel”, the entire contents of which are incorporated herein by reference.

### TECHNICAL FIELD

The present application relates to the field of display technologies, and more particularly, to a pixel drive circuit and a display panel.

### BACKGROUND

Active-matrix organic light-emitting diode (Active-matrix Organic Light-emitting Diode, OLED) display devices have been widely used in products such as televisions and mobile phones due to the characteristics of low power consumption, wide viewing angle, light weight, high brightness, and the like.

A pixel driving circuit is configured to drive a pixel unit in the display device, and a stability of the pixel driving circuit affects a display quality of the display device.

### SUMMARY

In any display period, a pixel driving circuit needs to realize normal display of images by driving a thin film transistor (TFT), however, drifting of a threshold voltage for driving the TFT is prone to occur due to variation of manufacturing process, aging of transistors, and the like. Thus, the stability of the pixel driving circuit is reduced, and the display quality is affected.

One of the objectives of the embodiments of the present application is to provide a pixel driving circuit and a display panel, which aim at improving the stability of the pixel driving circuit and thereby improving the display quality.

### TECHNICAL SOLUTIONS

In the first aspect, a pixel driving circuit is provided in the embodiments of the present application. The pixel driving circuit includes: a data input circuit, a reset circuit, an energy storage circuit, a compensation circuit, a luminescence control circuit, a first switch circuit, a second switch circuit, and a third switch circuit.

An input of the luminescence control circuit is electrically connected to a first power supply through the first switch circuit, an output of the luminescence control circuit is electrically connected to an anode of a luminescent device through the second switch circuit, a cathode of the luminescent device is electrically connected to a second power supply, and the luminescence control circuit is configured to output a driving current to the luminescent device in a luminescence phase.

An input of the compensation circuit is electrically connected to the input of the luminescence control circuit, and is electrically connected to a first end of the energy storage circuit through the third switch circuit; an output of the compensation circuit is electrically connected to an output of the data input circuit; wherein the data input circuit is configured to output a data voltage to the compensation circuit in a compensation and writing phase, and the compensation circuit is configured to compensate a threshold voltage of the luminescence control circuit according to the data voltage.

A first end of the energy storage circuit is electrically connected to a control terminal of the luminescence control circuit and a control terminal of the compensation circuit, respectively, and a second end of the energy storage circuit is electrically connected to an anode of the luminescent device; the energy storage circuit is configured to store electric energy.

The reset circuit is electrically connected to the anode of the luminescent device, and is configured to output a reset voltage to the anode of the luminescent device in a reset phase.

The first switch circuit is switched on in the reset phase and the luminescence phase and is switched off in the compensation and writing phase; the second switch circuit is switched on in the luminescence phase and is switched off in the reset phase and the compensation and writing phase; the third switch circuit is switched on in the reset phase and the compensation and writing phase and is switched off in the luminescence phase.

As a selectable embodiment of the embodiments of the present application, the compensation circuit includes a first thin film transistor (TFT). A control terminal of the first TFT is electrically connected to the first end of the energy storage circuit, an input of the first TFT is electrically connected to the input of the luminescence control circuit, and is electrically connected to the first end of the energy storage circuit through the third switch circuit, and an output of the first TFT is electrically connected to the output of the data input circuit. As a selectable embodiment of the embodiments of the present application, the luminescence control circuit includes a second TFT, a control terminal of the second TFT is electrically connected to the first end of the energy storage circuit, an input of the second TFT is electrically connected to the first power supply through the first switching circuit, and an output of the second TFT is electrically connected to the anode of the luminescent device through the second switching circuit.

As a selectable embodiment of the embodiments of the present application, the first switching circuit includes a first switching transistor and a first luminescence control signal line. A control terminal of the first switching transistor is electrically connected to an output of the first luminescence control signal line, an input of the first switching transistor is electrically connected to an output of the first power supply, and an output of the first switching transistor is electrically connected to the input of the luminescence control circuit.

As a selectable embodiment of the embodiments of the present application, the second switch circuit includes a second switching transistor and a second luminescence control signal line. A control terminal of the second switching transistor is electrically connected to an output of the second luminescence control signal line, an input of the second switching transistor is electrically connected to the output of the luminescence control circuit, and an output of the second switching transistor is electrically connected to the anode of the luminescent device. As a selectable embodiment of the embodiments of the present application, the third switching circuit includes a third switching transistor and a first scanning line. A control terminal of the third switching transistor is electrically connected to an output of the first scanning line, an input of the third switching transistor is electrically connected to the first terminal of the energy storage circuit, and an output of the third switching transistor is electrically connected to the input of the compensation circuit.

As a selectable embodiment of the embodiments of the present application, the reset circuit includes a fourth switch transistor, a second scanning line and a reset signal line. A control terminal of the fourth switch transistor is electrically connected to an output of the second scanning line, an input of the fourth switch transistor is electrically connected to an output of the reset signal line, an output of the fourth switch transistor is electrically connected to the anode of the luminescent device, and the reset signal line is configured to output the reset voltage.

As a selectable embodiment of the embodiments of the present application, the data input circuit includes a fifth switching transistor, a data line, and a third scanning line. A control terminal of the fifth switching transistor is electrically connected to an output of the third scanning line, an input of the fifth switching transistor is electrically connected to an output of the data line, an output of the fifth switching transistor is electrically connected to the output of the compensation circuit. The data line is configured to output the data voltage.

As a selectable embodiment of the embodiments of the present application, the luminescent device is an organic light-emitting diode (OLED).

As a selectable embodiment of the embodiments of the present application, the first luminescence control signal line is configured to output a high-level signal in the reset phase, and outputs a low-level signal in the compensation and writing phase, and the luminescence phase.

As a selectable embodiment of the embodiments of the present application, the first switching transistor is a N-channel metal oxide semiconductor (NMOS) transistor.

As a selectable embodiment of the embodiments of the present application, the luminescence control circuit includes a second TFT. A control terminal of the second TFT is electrically connected to the first end of the energy storage circuit, an input of the second TFT is electrically connected to the first power supply through the first switching circuit, and an output of the second TFT is electrically connected to the anode of the luminescent device through the second switching circuit. A threshold voltage of the first TFT is equal to a threshold voltage of the second TFT.

As a selectable embodiment of the embodiments of the present application, the reset circuit includes a fourth switch transistor, a second scanning line and a reset signal line. A control terminal of the fourth switch transistor is electrically connected to an output of the second scanning line, an input of the fourth switch transistor is electrically connected to an output of the reset signal line, an output of the fourth switch transistor is electrically connected to the anode of the luminescent device. The reset signal line is configured to output the reset voltage. The second scanning line and the first scanning line are the same scanning line.

As a selectable embodiment of the embodiments of the present application, the energy storage circuit includes aa capacitor.

In accordance with a second aspect, a display panel is provided in the embodiments of the present application. The display panel includes a plurality of pixel units, each of the plurality of pixel units includes a luminescent device and the pixel driving circuit.

The pixel driving circuit and the display panel provided in the embodiments of the present disclosure include: the data input circuit, the reset circuit, the energy storage circuit, the compensation circuit, the luminescence control circuit, the first switch circuit, the second switch circuit, and the third switch circuit. The input of the luminescence control circuit is electrically connected to the first power supply through the first switch circuit, the output of the luminescence control circuit is electrically connected to the anode of the luminescent device through the second switch circuit, the cathode of the luminescent device is electrically connected to the second power source. The luminescence control circuit is configured to output the driving current to the luminescent device in the luminescence phase. The input of the compensation circuit is electrically connected to the input of the luminescence control circuit and is electrically connected to the first end of the energy storage circuit through the third switch circuit, and the output of the compensation circuit is electrically connected to the output of the data input circuit. The data input circuit is configured to output the data voltage to the compensation circuit in the compensation and writing phase, and the compensation circuit is configured to compensate the threshold voltage of the luminescence control circuit according to the data voltage. The first end of the energy storage circuit is electrically connected to the control terminal of the luminescence control circuit and the control terminal of the compensation circuit respectively, and the second end of the energy storage circuit is electrically connected to the anode of the luminescent device. The energy storage circuit is configured to store electric energy. The reset circuit is electrically connected to the anode of the luminescent device, and is configured to output the reset voltage to the anode of the luminescent device in the reset phase. The first switch circuit is switched on in the reset phase and the luminescence phase and is switched off in the compensation and writing phase. The second switch circuit is switched on in the luminescence phase, and is switched off in the reset phase and the compensation and writing phase. The third switch circuit is switched on in the reset phase and the compensation and writing phase and is switched off in the luminescence phase. In the aforesaid technical solutions, in the compensation and writing phase, the compensation circuit is used to compensate the threshold voltage of the luminescence control circuit according to the data voltage, thus, the driving current of the luminescent device may be controlled according to the data voltage and the reset voltage in the luminescence phase, and the driving current of the luminescent device is irrelevant with the threshold voltage of the luminescence control circuit. In this way, the phenomena including uneven brightness of the display panel caused due to drifting of the threshold voltage may be reduced, and an uniformity of brightness of the display panel is improved. Moreover, in the present application, compensation and luminescence are completed by the compensation circuit and the luminescence control circuit respectively. Thus, a driving frequency of the second TFT in the luminescence control circuit may be reduced, performance degradation speeds of the circuit components in the pixel driving circuit is slowed down, the stability of the pixel driving circuit is improved, and the display quality is further improved.

### DESCRIPTION OF THE DRAWINGS

In order to describe the embodiments of the present application more clearly, a brief introduction regarding the accompanying drawings that need to be used for describing the embodiments is given below. It is obvious that the accompanying drawings described below are merely some embodiments of the present application, a person of ordinary skill in the art may also acquire other drawings according to the current drawings without paying creative works.

FIG. 1 is a schematic diagram of a circuit configuration of a pixel driving circuit according to a demonstrated technology;

FIG. 2 is a schematic structural diagram of any pixel unit in a display panel according to one embodiment of the present application;

FIG. 3 is a schematic circuit configuration of the pixel driving circuit in FIG. 2;

FIG. 4 is an operation timing sequence diagram of the pixel driving circuit according to one embodiment of the present application;

FIG. 5 is an equivalent circuit configuration of a reset phase according to one embodiment of the present application;

FIG. 6 is an equivalent circuit configuration of a compensation and writing phase according to one embodiment of the present application;

FIG. 7 is an equivalent circuit configuration of a luminescence phase according to one embodiment of the present application; and

FIG. 8 is a schematic structural diagram of a display panel according to one embodiment of the present application.

### DETAILED DESCRIPTION OF EMBODIMENTS

In order to make the objective, the technical solutions and the advantages of the present application be clearer, the embodiments of the present application are further described in detail below with reference to the accompanying drawings.

The terms used in the embodiments of the present application are only intended to illustrate the embodiments of the present application, rather than limiting the present application. The following embodiments may be combined with each other, the same or similar concepts or processes may not be repeatedly described in some embodiments.

A luminescent device in the embodiments of the present application may be any one of an organic light-emitting diode (Organic Light-Emitting Diode, OLED), an inorganic light-emitting diode (Light-Emitting Diode, LED), a quantum dot light-emitting diode (Quantum Dot Light-Emitting Diode, QLED), and a mini light-emitting diode (Mini light-emitting diode, LED). For the convenience of description, the present application is exemplarily described below by taking the luminescent device as an OLED as an example.

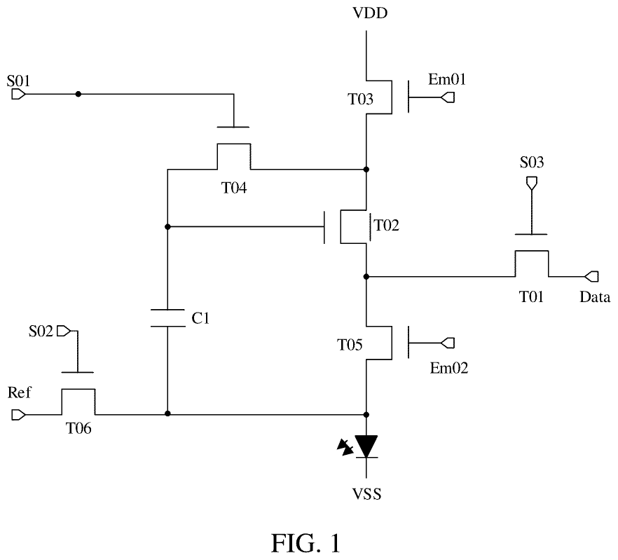

FIG. 1 is a schematic structural diagram of an exemplary pixel driving circuit. As shown in FIG. 1, the pixel driving circuit may include a switching transistor T01, a switching transistor T03, a switching transistor T04, a switching transistor T05, a switching transistor T06, a driving thin film transistor (TFT) T02, a capacitor C1, and an OLED.

A control terminal of the switching transistor T01 is electrically connected to a scanning line S03, an input of the switching transistor T01 is electrically connected to an output of a data line Data, and an output of the switching transistor T01 is electrically connected to an output of the driving TFT T02.

The input of the driving TFT T02 is electrically connected to the first power supply VDD through the switching transistor T03, and is electrically connected to a control terminal of the driving TFT T02 through the switching transistor T04, and the output of the driving TFT T02 is electrically connected to an anode of the OLED through the switching transistor T05. A control terminal of the switching transistor T03 is connected to an output of a luminescence control signal line Em01. A control terminal of the switching transistor T04 is connected to the scanning line S01. A control terminal of the switching transistor T05 is electrically connected to an output of a luminescence control signal line Em02. The driving TFT T02 is configured to provide a driving current to the OLED in a luminescence phase to drive the OLED to emit light.

Two ends of the capacitor C1 are connected between the control terminal of the driving TFT T02 and the anode of the OLED, in order to store electric energy.

A control terminal of the switch transistor T06 is electrically connected to an output of the scanning line S02, an input of the switch transistor T06 is electrically connected to an output of the reset signal line REF, and an output of the switch transistor T06 is electrically connected to an anode of the luminescent device.

Where, in the reset phase, the switching transistor T03, the switching transistor T04, and the switching transistor T06 are switched on, the switching transistor T01, the switching transistor T05, and the driving TFT T02 are switched off. The first power supply VDD outputs the first voltage to charge the capacitor C1, and the reset voltage Vref output by a reset signal line Ref resets the anode of the OLED. In the compensation and writing phase, the switching transistor T01, the switching transistor T04, and the switching transistor T06 are switched on, the switching transistor T03 and the switching transistor T05 are switched off, the data line Data outputs a data voltage through the switching transistor T01, the driving TFT T02 is switched on under the action of the capacitor C1, after the voltage at the control terminal of the driving TFT T02 reaches the sum of the data voltage and the threshold voltage of the driving TFT T02, the voltage at the control terminal of the driving TFT 02 drives the TFT T02 to be switched off, and the compensation writing is completed. In the luminescence phase, the switching transistor T03 and the switching transistor T05 are switched on, the driving TFT T02 is switched on under the action of the capacitor C1, and provides a driving current to the OLED to enable the OLED to emit light.

Since the pixel driving circuit generally suffers a reset phase, a compensation and writing phase and a luminescence phase in each luminescent period during operation of the pixel driving circuit, both the compensation and writing phase and the luminescence phase need to be completed by the driving TFT T02. Thus, during long-time and high-frequency use, a performance degradation speed of the driving TFT T02 is relatively fast and a stability of the pixel driving circuit may be reduced quickly, and a display quality of the display panel may be affected accordingly.

In view of this, embodiments of the present application provide a pixel driving circuit and a display panel, which aim to improve the stability of the pixel driving circuit and further improve the display quality of the display panel.

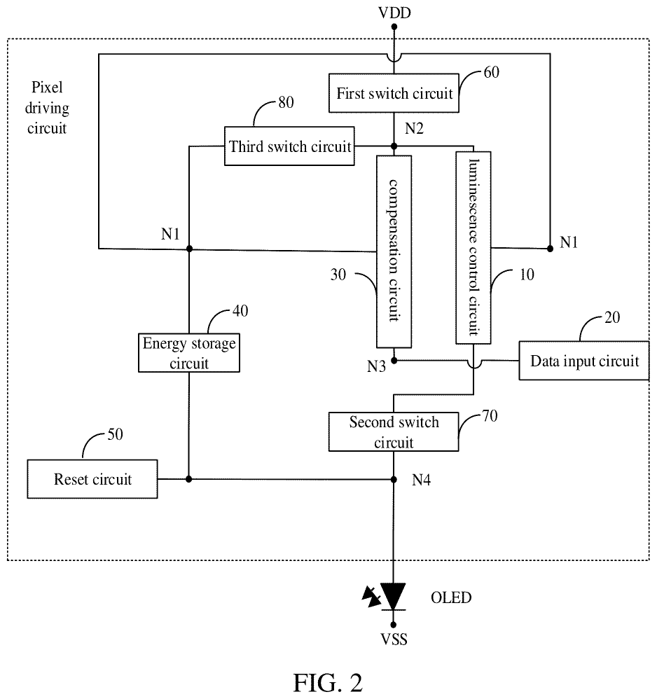

The display panel provided in this embodiment of the present application may include a plurality of pixel units. FIG. 2 is a schematic structural diagram of any pixel unit in the display panel according to one embodiment of the present application, as shown in FIG. 2, the pixel unit may include a first power supply VDD, a second power supply VSS, a pixel driving circuit, and an OLED.

The first power supply VDD may output a high-level voltage, and correspondingly, the second power supply VSS may output a low-level voltage.

The pixel driving circuit may include a luminescence control circuit 10, a data input circuit 20, a compensation circuit 30, an energy storage circuit 40, a reset circuit 50, a first switch circuit 60, a second switch circuit 70, and a third switch circuit 80.

An input of the luminescence control circuit 10 is electrically connected to the first power supply VDD through the first switch circuit 60, an output of the luminescence control circuit 10 is electrically connected to an anode of the OLED through the second switch circuit 70, a cathode of the OLED is electrically connected to the second power supply VSS. The luminescence control circuit 10 is configured to output a driving current to the OLED in a luminescence phase.

An input of the compensation circuit 30 is electrically connected to an input of the luminescence control circuit 10, and is electrically connected to a first end of the energy storage circuit 40 through the third switch circuit 80. An output of the compensation circuit 30 is electrically connected to an output of the data input circuit 20. The data input circuit 20 is configured to output a data voltage to the compensation circuit 30 in a compensation and writing phase, and the compensation circuit 30 is configured to compensate a threshold voltage of the luminescence control circuit 10 according to the data voltage.

A first end of the energy storage circuit 40 is electrically connected to a control terminal of the luminescence control circuit 10 and a control terminal of the compensation circuit 30 respectively, and a second end of the energy storage circuit 40 is electrically connected to the anode of the OLED. The energy storage circuit 40 may be configured to store electric energy.

The reset circuit 50 is electrically connected to the anode of the OLED, and is configured to output a reset voltage to the anode of the OLED in the reset phase.

The first switch circuit 60 is switched on in the reset phase and the luminescence phase, and is switched off in the compensation and writing phase. The second switch circuit 70 is switched on in the luminescence phase, and is switched off in the reset phase and the compensation and writing phase. The third switch circuit 80 is switched on in the reset phase and the compensation and writing phase, and is switched off in the luminescence phase.

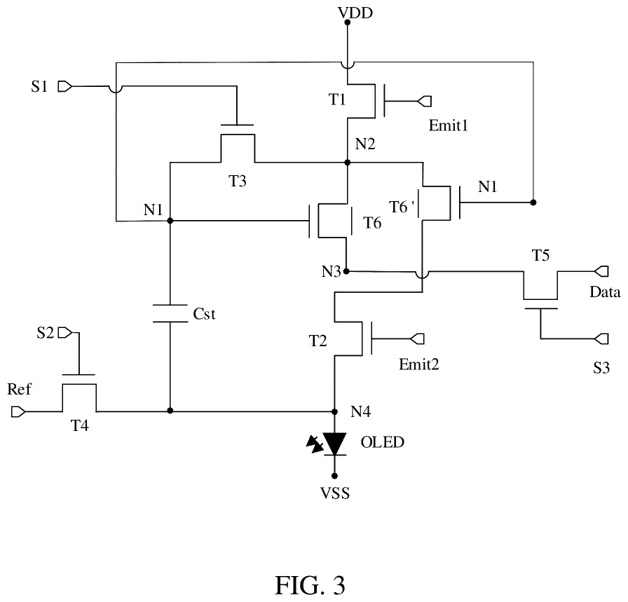

FIG. 3 is a schematic diagram of a circuit configuration of the pixel driving circuit in FIG. 2. As shown in FIG. 3, the first switch circuit 60 may include a first switch transistor T1 and a first luminescence control signal line Emit1. A control terminal of the first switch transistor T1 is electrically connected to an output of the first luminescence control signal line Emit1, an input of the first switch transistor T1 is electrically connected to an output of the first power supply VDD, and an output of the first switch transistor T1 is electrically connected to the input of the luminescence control circuit 10.

The second switching circuit 70 may include a second switching transistor T2 and a second luminescence control signal line Emit2. A control terminal of the second switching transistor T2 is electrically connected to an output of the second luminescence control signal line Emit2, an input of the second switching transistor T2 is electrically connected to the output of the luminescence control circuit 10, and an output of the second switching transistor T2 is electrically connected to the anode of the OLED.

The third switching circuit 80 may include a third switching transistor T3 and a first scanning line S1. A control terminal of the third switching transistor T3 is electrically connected to an output of the first scanning line S1, an input of the third switching transistor T3 is electrically connected to a first end of the energy storage circuit 40, and an output of the third switching transistor T3 is electrically connected to the input of the compensation circuit 30.

The reset circuit 50 may include a fourth switch transistor T4, a second scanning line S2, and a reset signal line Ref. A control terminal of the fourth switch transistor T4 is electrically connected to an output of the second scanning line S2, an input of the fourth switch transistor T4 is electrically connected to an output of the reset signal line Ref, and an output of the fourth switch transistor T4 is electrically connected to the anode of the OLED. The reset signal line Ref is configured to output a reset voltage Vref It should be noted that the first scanning line S1 (which may also be referred to as the scanning line S1) and the second scanning line S2 (which may also be referred to as the scanning line S2) may be different scanning lines or be the same scanning line, in order to reduce the complexity of the circuit.

The data input circuit 20 may include a fifth switch transistor T5, a data line Data, and a scanning line S3 (i.e., a third scanning line). A control terminal of the fifth switch transistor T5 is electrically connected to an output of the scanning line S3, an input of the fifth switch transistor T5 is electrically connected to an output of the data line Data, and an output of the fifth switch transistor T5 is electrically connected to the output of the compensation circuit 30. The data line Data is configured to output a data voltage.

The compensation circuit 30 may include a first TFT T6 (which may also be referred to as a compensation TFT), a control terminal of the first TFT T6 is electrically connected to the first end of the energy storage circuit 40, an input of the first TFT T6 is electrically connected to the input of the luminescence control circuit 10 and is further electrically connected to the first end of the energy storage circuit 40 through the third switch circuit 80, and an output of the first TFT T6 is electrically connected to an output of the data input circuit 20.

The compensation circuit 30 is configured to compensate a threshold voltage Vth of the second TFT T6′, and correspondingly, the threshold voltage of the first TFT T6 is equal to the threshold voltage Vth of the second TFT T6′.

The luminescence control circuit 10 includes a second TFT T6′, a control terminal of the second TFT T6′ is electrically connected to the first end of the energy storage circuit 40, an input of the second TFT T6′ is electrically connected to the first power supply VDD through the first switch circuit 60, and an output of the second TFT T6′ is electrically connected to the anode of the OLED through the second switch circuit 70.

The energy storage circuit 40 may include a capacitor Cst. One end of the capacitor Cst is electrically connected to the input of the third switch transistor T3, and is also electrically connected to the control terminal of the first TFT T6 and the control terminal of the second TFT T6′ respectively, and the other end of the capacitor Cst is electrically connected to the anode of the OLED.

Where, the switching transistors T1, T2, T3, T4, T5 and the TFTs T6 and T6′ may be at least one of a triode or a metal-oxide-semiconductor field-effect transistor (Metal-Oxide-Semiconductor Field-Effect Transistor, MOSFET). The switching transistors T1, T2, T3, T4, T5 may be transistors of the same type, or be different types of transistors. For the convenience of description, this embodiment of the present application are exemplarily described below by taking the switching transistors T1, T2, T3, T4, and T5 as N-channel metal-oxide-semiconductor transistors (N-channel-Metal-Oxide-Semiconductor, NMOS) as an example.

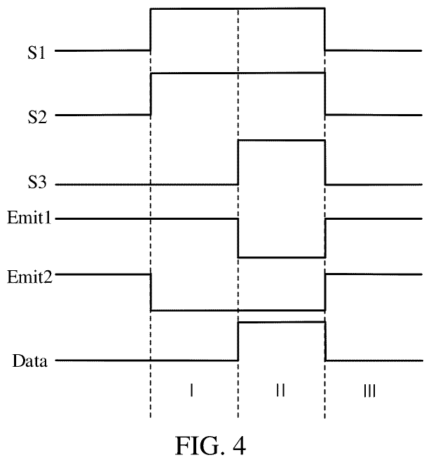

FIG. 4 is a timing sequence diagram of the pixel driving circuit according to one embodiment of the present application. As shown in FIG. 4, each luminescent period of the pixel driving circuit may be divided into a reset phase I, a compensation and writing phase II, and a luminescence phase III.

Where, in the reset phase I, the scanning line S1, the scanning line S2, and the first luminescence control signal line Emit1 output a high level signal, the scanning line S3 and the second luminescence control signal line Emit2 output a low level signal.

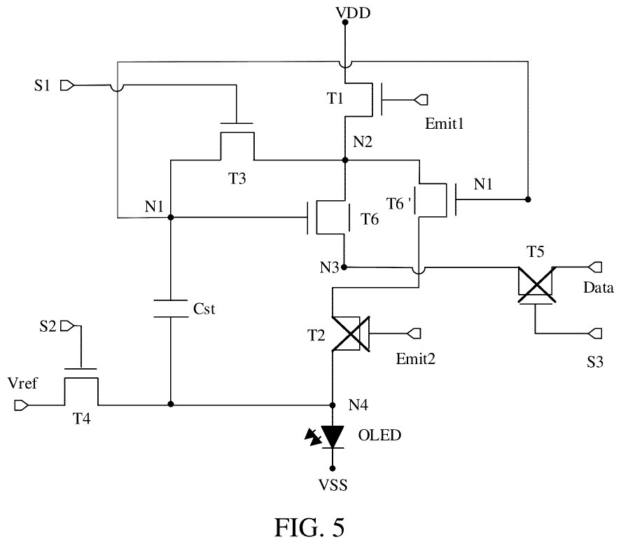

Correspondingly, an equivalent circuit diagram of the pixel driving circuit is shown in FIG. 5. The first switching transistor T1, the third switching transistor T3, and the fourth switching transistor T4 are switched on, and the second switching transistor T2 and the fifth switching transistor T5 are switched off (the switching transistor in the switched off state is represented by “X”).

In the reset stage, the first power supply VDD charges the capacitor Cst, and a voltage at a node N1 and a voltage at a node N2 is raised to the output voltage VDD of the first power supply VDD. The reset signal line Ref outputs the reset voltage Vref to the capacitor Cst and the anode of the OLED, and a voltage at a node N4 is raised to the reset voltage Vref of the reset signal line Ref.

In the compensation and writing phase II, the scanning line S1, the scanning line S2, the scanning line S3, and the data line Data output a high level signal, the first luminescence control signal line Emit1 and the second luminescence control signal line Emit2 output a low level signal.

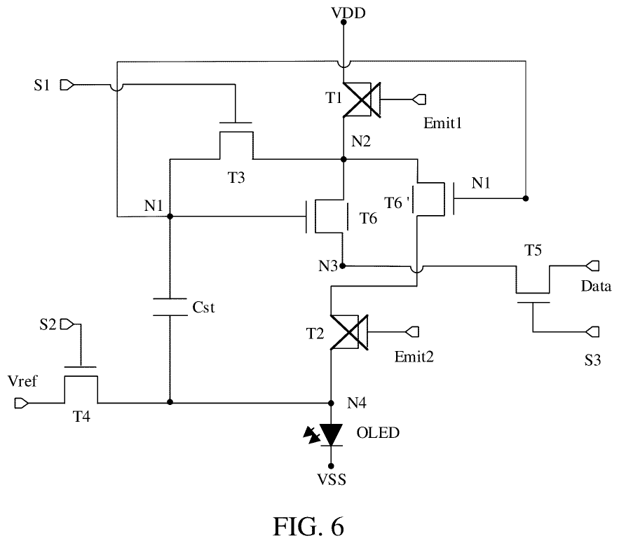

Correspondingly, an equivalent circuit diagram of the pixel driving circuit is shown in FIG. 6. The third switching transistor T3, the fourth switching transistor T4, and the fifth switching transistor T5 are switched on, the first switching transistor T1 and the second switching transistor T2 are switched off.

In the compensation writing stage, the data line Data outputs the data voltage Vdata to the node N3 through the fifth switching transistor T5, the first TFT T6 is switched on under the action of the capacitor Cst, after the potential of the node N1 is equal to the sum of the data voltage Vdata and the threshold voltage Vth of the first TFT T6, the first TFT T6 is switched off, the voltages at the node N1 and the voltage at the node N2 are Vdata+Vth, the voltage at the node N3 is Vdata. In addition, the reset signal line Ref outputs a reset voltage Vref to the capacitor Cst and the anode of the OLED, and the voltage of the node N 4 is maintained as Vref.

In the luminescence phase III, the first luminescence control signal line Emit1 and the second luminescence control signal line Emit2 output a high-level signal. The scanning line S1, the scanning line S2, the scanning line S3, and the data line Data output a low-level signal.

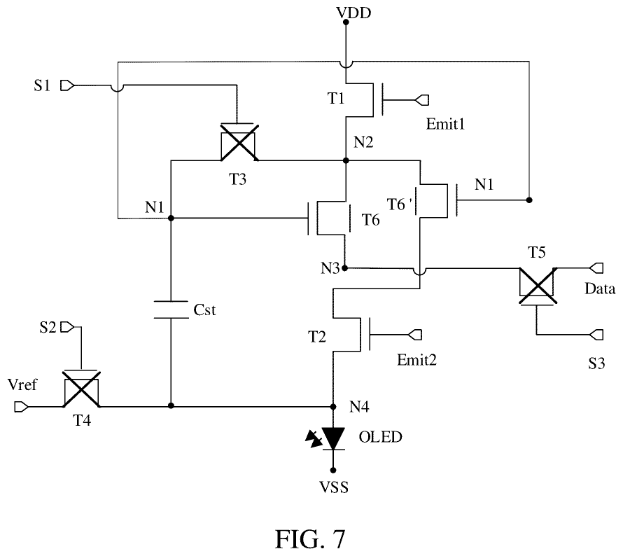

Correspondingly, an equivalent circuit diagram of the pixel driving circuit is shown in FIG. 7, the first switching transistor T1, the second switching transistor T2 are switched on, the second TFT T6′ is switched on. The third switching transistor T3, the fourth switching transistor T4, and the fifth switching transistor T5 are switched off.

In the luminescence stage, the first power supply VDD, the first switching transistor T1, the second TFT T6′ and the second switching transistor T2 form a path, the luminescence control circuit 10 outputs a driving current to the OLED to enable the OLED to emit light.

After the second switch transistor T2 is switched on, the voltage at the node N4 is Vss+Voled, the voltage at the second end of the capacitor Cst jumps from Vref to Vss+Voled, and a jump variable is Δ=Vss+Voled−Vref. Due to a coupling effect of the capacitor Cst, a voltage variation of the node N1 is the same as a voltage variation of the node N4, and the voltage of the node N1 becomes Vdata+Vth+Vss+Voled−Vref. Where, the Voled is a voltage of the OLED when the OLED emits light.

The driving current of the OLED may be determined according to the following formula:

Ioled=1/2·k·(Vgs−Vth)²

where, Ioled represents the driving current of the OLED, k=μn·Cox·W/L, μn represents an electron mobility of the second TFT T6′, Cox represents an unit area capacitance of a gate oxide of the second TFT T6′, W/L represents a width-to-length ratio of the second TFT T6′, Vgs represents a voltage of a gate electrode of the second TFT T6′ (i.e., the control terminal of the second TFT T6′) with respect to a source electrode (i.e., the output of the second TFT T6′) of the second TFT T6′, and Vth represents a threshold voltage of the second TFT T6′.

The gate-source voltage of the second TFT T6′ is expressed as:

Vgs=V_{N1}−V_{N4}=(Vdata+Vth+Vss+Voled−Vref)−(Vss+Voled)=Vdata+Vth−Vref.

A following formula may be obtained according to a driving current calculation formula of the OLED:

Ioled=1/2·k·(Vdata−Vref)²

It is clear from the aforesaid formula that, in the pixel driving circuit provided in the present application, the driving current of the OLED is only related to the data voltage Vdata and the reset voltage Vref, and is irrelative with the threshold voltage Vth of the second TFT T6′. Thus, the influence of the threshold voltage of the second TFT T6′ on the brightness of luminance of the OLED is eliminated, the uniformity of brightness of the OLED is improved, and the display quality is further improved. In addition, since the compensation and writing phase II and the luminescence phase III are driven by TFTs of different circuits, the performance degradation speed caused due to frequently driving of the same TFT may be slowed down. In this way, the stability of the pixel driving circuit may be improved, and the display quality may be further improved.

It may be understood that the circuit modules shown in this embodiment of the present application are not constituted as specific limitation on the pixel driving circuit. In some other embodiments of the present application, the pixel driving circuit may include more or fewer circuit modules than those shown in the figures; or alternatively, some circuit modules may be combined, or some circuit modules may be divided. Each circuit module may include more or fewer components than those shown in the figures. The illustrated circuit module may be implemented in hardware, software, or a combination of software and hardware.

The pixel driving circuit and the display panel provided in the embodiments of the present disclosure include: the data input circuit, the reset circuit, the energy storage circuit, the compensation circuit, the luminescence control circuit, the first switch circuit, the second switch circuit, and the third switch circuit. The input of the luminescence control circuit is electrically connected to the first power supply through the first switch circuit, the output of the luminescence control circuit is electrically connected to the anode of the luminescent device through the second switch circuit, the cathode of the luminescent device is electrically connected to the second power source. The luminescence control circuit is configured to output the driving current to the luminescent device in the luminescence phase. The input of the compensation circuit is electrically connected to the input of the luminescence control circuit and is electrically connected to the first end of the energy storage circuit through the third switch circuit, and the output of the compensation circuit is electrically connected to the output of the data input circuit. The data input circuit is configured to output the data voltage to the compensation circuit in the compensation and writing phase, and the compensation circuit is configured to compensate the threshold voltage of the luminescence control circuit according to the data voltage. The first end of the energy storage circuit is electrically connected to the control terminal of the luminescence control circuit and the control terminal of the compensation circuit respectively, and the second end of the energy storage circuit is electrically connected to the anode of the luminescent device. The energy storage circuit is configured to store electric energy. The reset circuit is electrically connected to the anode of the luminescent device, and is configured to output the reset voltage to the anode of the luminescent device in the reset phase. The first switch circuit is switched on in the reset phase and the luminescence phase and is switched off in the compensation and writing phase. The second switch circuit is switched on in the luminescence phase, and is switched off in the reset phase and the compensation and writing phase. The third switch circuit is switched on in the reset phase and the compensation and writing phase and is switched off in the luminescence phase. In the aforesaid technical solutions, in the compensation and writing phase, the compensation circuit is used to compensate the threshold voltage of the luminescence control circuit according to the data voltage, thus, the driving current of the luminescent device may be controlled according to the data voltage and the reset voltage in the luminescence phase, and the driving current of the luminescent device is irrelevant with the threshold voltage of the luminescence control circuit. In this way, the phenomena including uneven brightness of the display panel caused due to drifting of the threshold voltage may be reduced, and an uniformity of brightness of the display panel is improved. Moreover, in the present application, compensation and luminescence are completed by the compensation circuit and the luminescence control circuit respectively. Thus, the driving frequency of the TFT in the luminescence control circuit may be reduced, performance degradation speeds of the circuit components in the pixel driving circuit is slowed down, the stability of the pixel driving circuit is improved, and the display quality is further improved. Since the performance degradation speeds of the circuit components in the pixel driving circuit are slowed down, a service life of the pixel driving circuit may be prolonged accordingly.

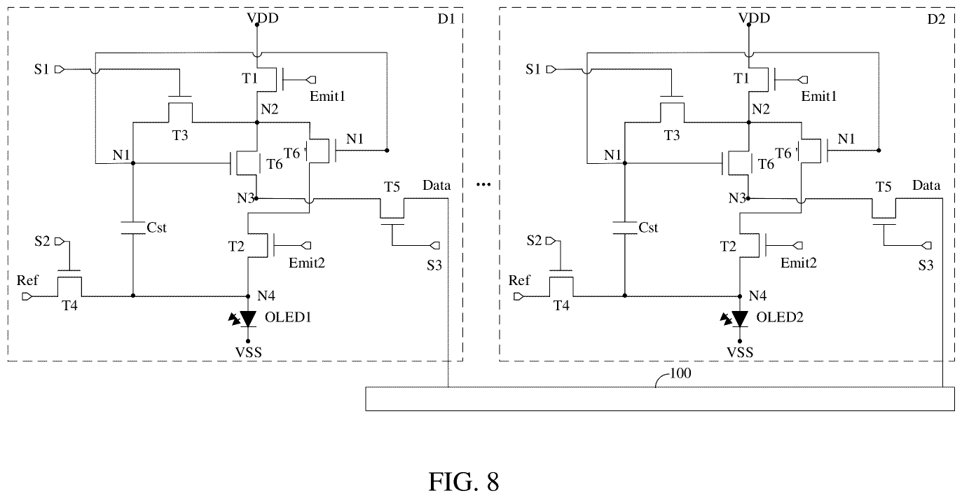

Based on the same inventive concept, a display panel is further provided in the embodiments of the present application. FIG. 8 is a schematic structural diagram of the display panel according to one embodiment of the present application. As shown in FIG. 8, the display panel may include a plurality of pixel units, and each of the plurality of pixel units may include a luminescent device and the aforesaid pixel driving circuit. For example, a pixel unit D1 may include a luminescent device OLED1 and a pixel driving circuit.

The display panel provided in this embodiment of the present application may further include a data driving circuit 100. The data driving circuit 100 may be integrated into a main control chip (not shown in the figures). An output of the data driving circuit 100 may be electrically connected to the data input circuit 20 in each pixel unit. The data driving circuit 100 is configured to generate a data voltage for the data input circuit 20.

In the embodiments of the present application, the descriptions of the embodiments in the present application are emphasized respectively. Regarding the part in some embodiments which is not described in detail, reference can be made to related descriptions in other embodiments.

It should be understood that, in the description of the specification and the claims of the present application, the terms “comprising”, “including”, “having” and their variations are intended to cover non-exclusive inclusion, and mean “including but is not limited to”, unless otherwise these terms are specially emphasized in other manner.

In the descriptions of the present application, “/” has the meaning of “or” between two consecutive associated objects, unless otherwise there is definition of “/”. For example, A/B may represent A or B. The phrase of “and/or” in the context is an association relationship for describing the associated objects, and indicates that three relationships may exist. For example, A and/or B may represent that A exists alone, A and B exist at the same time, and B exists alone. Where, A and B may be single or plural.

Moreover, in the descriptions of the present application, the term of “a plurality of” indicates two or more than two, unless otherwise the term is additionally defined. “at least one of the following items” or the similar expression indicates any combination of these items, which includes any combination of one single item or a plurality of items.

Additionally, in the present application, unless there are additional explicit stipulation and limitation, terms such as “connect”, “connect with each other” and the like should be generalizedly interpreted. For example, “connect” may be interpreted as being mechanically connected or electrically connected; “connect” may also be interpreted as being directly connected or indirectly connected through intermediary; “connect” may also be interpreted as internal communication between two components or an interaction relationship between the two components, unless there is additional explicit limitation. The specific meanings of the aforesaid terms in the present application may be interpreted by the person of ordinary skill in the art according to specific conditions.

In addition, in the descriptions of the specification and the annexed claims of the present application, the terms such as “first”, “second” and the like are used to distinguish similar objects and do not necessarily need to be used for describing a specific order or sequence, these terms cannot be interpreted as indicating or implying relative importance or implying the number of the indicated technical features. It should be understood that the data used in this way may be interchanged in an appropriate condition. Thus, the embodiments described herein may be implemented in an order other than that illustrated or described herein. Features that are limited by “first” and “second” may explicitly or implicitly include at least one of these features.

In the embodiments of the present application, phrases such as “exemplarily” or “for example” are used to indicate examples, illustrations, or explanations. Any embodiment or design scheme described as “exemplarily” or “for example” in the present application should not be interpreted as being more preferrable or more advantageous than other embodiments or design schemes. Specifically, the use of the phrase such as “exemplarily” or “for example” is intended to present relevant concepts in a specific manner.

The descriptions of “referring to one embodiment” and “referring to some embodiments”, and the like as described in the specification of the present application means that a specific feature, structure, or characters which are described with reference to this embodiment are included in one embodiment or some embodiments of the present application. Thus, the phrases of “in one embodiment”, “in some embodiments”, “in some other embodiments”, “in other embodiments”, and the like in this specification are not necessarily referring to the same embodiment, but instead indicate “one or more embodiments instead of all embodiments”, unless otherwise these phrases are specially emphasized in other manner.

Finally, it should be noted that, the various embodiments mentioned above are only intended to explain the technical solutions of the present application, rather than being constituted as limitations to the technical solutions of the present application. Although the present application has been described in detail with reference to these embodiments, a person of ordinary skilled in the art should understand that, the technical solutions disclosed in the embodiments may also be amended, some technical features in the technical solutions may also be equivalently replaced. The amendments or the equivalent replacements don't cause the essence of the corresponding technical solutions to be deviated from the spirit and the scope of the technical solutions in the embodiments of the present application.

1. A pixel driving circuit, comprising: a data input circuit, a reset circuit, an energy storage circuit, a compensation circuit, a luminescence control circuit, a first switch circuit, a second switch circuit, and a third switch circuit;
wherein an input of the luminescence control circuit is electrically connected to a first power supply through the first switch circuit, an output of the luminescence control circuit is electrically connected to an anode of a luminescent device through the second switch circuit, a cathode of the luminescent device is electrically connected to a second power supply, and the luminescence control circuit is configured to output a driving current to the luminescent device in a luminescence phase;
an input of the compensation circuit is electrically connected to the input of the luminescence control circuit, and is electrically connected to a first end of the energy storage circuit through the third switch circuit; an output of the compensation circuit is electrically connected to an output of the data input circuit; wherein the data input circuit is configured to output a data voltage to the compensation circuit in a compensation and writing phase, and the compensation circuit is configured to compensate a threshold voltage of the luminescence control circuit according to the data voltage;
a first end of the energy storage circuit is electrically connected to a control terminal of the luminescence control circuit and a control terminal of the compensation circuit, respectively, and a second end of the energy storage circuit is electrically connected to an anode of the luminescent device; the energy storage circuit is configured to store electric energy;
the reset circuit is electrically connected to the anode of the luminescent device, and is configured to output a reset voltage to the anode of the luminescent device in a reset phase; and
the first switch circuit is switched on in the reset phase and the luminescence phase and is switched off in the compensation and writing phase; the second switch circuit is switched on in the luminescence phase and is switched off in the reset phase and the compensation and writing phase; the third switch circuit is switched on in the reset phase and the compensation and writing phase and is switched off in the luminescence phase.

2. The pixel driving circuit according to claim 1, wherein the compensation circuit comprises a first thin film transistor (TFT), a control terminal of the first TFT is electrically connected to the first end of the energy storage circuit, an input of the first thin TFT is electrically connected to the input of the luminescence control circuit, and is electrically connected to the first end of the energy storage circuit through the third switch circuit, and an output of the first TFT is electrically connected to the output of the data input circuit.

3. The pixel driving circuit according to claim 1, wherein the luminescence control circuit comprises a second TFT, wherein a control terminal of the second TFT is electrically connected to the first end of the energy storage circuit, an input of the second TFT is electrically connected to the first power supply through the first switching circuit, and an output of the second TFT is electrically connected to the anode of the luminescent device through the second switching circuit.

4. The pixel driving circuit according to claim 1, wherein the first switching circuit comprises a first switching transistor and a first luminescence control signal line, a control terminal of the first switching transistor is electrically connected to an output of the first luminescence control signal line, an input of the first switching transistor is electrically connected to an output of the first power supply, and an output of the first switching transistor is electrically connected to the input of the luminescence control circuit.

5. The pixel driving circuit according to claim 1, wherein the second switch circuit comprises a second switching transistor and a second luminescence control signal line, a control terminal of the second switching transistor is electrically connected to an output of the second luminescence control signal line, an input of the second switching transistor is electrically connected to the output of the luminescence control circuit, and an output of the second switching transistor is electrically connected to the anode of the luminescent device.

6. The pixel driving circuit according to claim 1, wherein the third switching circuit comprises a third switching transistor and a first scanning line, a control terminal of the third switching transistor is electrically connected to an output of the first scanning line, an input of the third switching transistor is electrically connected to the first terminal of the energy storage circuit, and an output of the third switching transistor is electrically connected to the input of the compensation circuit.

7. The pixel driving circuit according to claim 1, wherein the reset circuit comprises a fourth switch transistor, a second scanning line and a reset signal line, a control terminal of the fourth switch transistor is electrically connected to an output of the second scanning line, an input of the fourth switch transistor is electrically connected to an output of the reset signal line, an output of the fourth switch transistor is electrically connected to the anode of the luminescent device, and the reset signal line is configured to output the reset voltage.

8. The pixel driving circuit according to claim 1, wherein the data input circuit comprises a fifth switching transistor, a data line, and a third scanning line, a control terminal of the fifth switching transistor is electrically connected to an output of the third scanning line, an input of the fifth switching transistor is electrically connected to an output of the data line, an output of the fifth switching transistor is electrically connected to the output of the compensation circuit; the data line is configured to output the data voltage.

9. The pixel driving circuit according to claim 1, wherein the luminescent device is an organic light-emitting diode (OLED).

10. The pixel driving circuit according to claim 4, wherein the first luminescence control signal line is configured to output a high-level signal in the reset phase, and outputs a low-level signal in the compensation and writing phase and the luminescence phase.

11. The pixel driving circuit according to claim 4, wherein the first switching transistor is a N-channel metal oxide semiconductor (NMOS) transistor.

12. The pixel driving circuit according to claim 6, wherein the luminescence control circuit comprises a second TFT, a control terminal of the second TFT is electrically connected to the first end of the energy storage circuit, an input of the second TFT is electrically connected to the first power supply through the first switching circuit, and an output of the second TFT is electrically connected to the anode of the luminescent device through the second switching circuit; a threshold voltage of the first TFT is equal to a threshold voltage of the second TFT.

13. The pixel driving circuit according to claim 6, wherein the reset circuit comprises a fourth switch transistor, a second scanning line and a reset signal line, a control terminal of the fourth switch transistor is electrically connected to an output of the second scanning line, an input of the fourth switch transistor is electrically connected to an output of the reset signal line, an output of the fourth switch transistor is electrically connected to the anode of the luminescent device; the reset signal line is configured to output the reset voltage; the second scanning line and the first scanning line are a same scanning line.

14. The pixel driving circuit according to claim 1, wherein the energy storage circuit comprises a capacitor.

15. A display panel, comprising a plurality of pixel units, each of the plurality of pixel units comprising a luminescent device and a pixel driving circuit, the pixel driving circuit comprising:
a data input circuit, a reset circuit, an energy storage circuit, a compensation circuit, a luminescence control circuit, a first switch circuit, a second switch circuit, and a third switch circuit;
wherein an input of the luminescence control circuit is electrically connected to a first power supply through the first switch circuit, an output of the luminescence control circuit is electrically connected to an anode of a luminescent device through the second switch circuit, a cathode of the luminescent device is electrically connected to a second power supply, and the luminescence control circuit is configured to output a driving current to the luminescent device in a luminescence phase;
an input of the compensation circuit is electrically connected to the input of the luminescence control circuit, and is electrically connected to a first end of the energy storage circuit through the third switch circuit; an output of the compensation circuit is electrically connected to an output of the data input circuit; wherein the data input circuit is configured to output a data voltage to the compensation circuit in a compensation and writing phase, and the compensation circuit is configured to compensate a threshold voltage of the luminescence control circuit according to the data voltage;
a first end of the energy storage circuit is electrically connected to a control terminal of the luminescence control circuit and a control terminal of the compensation circuit, respectively, and a second end of the energy storage circuit is electrically connected to an anode of the luminescent device; the energy storage circuit is configured to store electric energy;
the reset circuit is electrically connected to the anode of the luminescent device, and is configured to output a reset voltage to the anode of the luminescent device in a reset phase; and
the first switch circuit is switched on in the reset phase and the luminescence phase and is switched off in the compensation and writing phase; the second switch circuit is switched on in the luminescence phase and is switched off in the reset phase and the compensation and writing phase; the third switch circuit is switched on in the reset phase and the compensation and writing phase and is switched off in the luminescence phase.

16. The display panel according to claim 15, wherein the compensation circuit comprises a first thin film transistor (TFT), a control terminal of the first TFT is electrically connected to the first end of the energy storage circuit, an input of the first thin TFT is electrically connected to the input of the luminescence control circuit, and is electrically connected to the first end of the energy storage circuit through the third switch circuit, and an output of the first TFT is electrically connected to the output of the data input circuit.

17. The display panel according to claim 15, wherein the luminescence control circuit comprises a second TFT, wherein a control terminal of the second TFT is electrically connected to the first end of the energy storage circuit, an input of the second TFT is electrically connected to the first power supply through the first switching circuit, and an output of the second TFT is electrically connected to the anode of the luminescent device through the second switching circuit.

18. The display panel according to claim 15, wherein the first switching circuit comprises a first switching transistor and a first luminescence control signal line, a control terminal of the first switching transistor is electrically connected to an output of the first luminescence control signal line, an input of the first switching transistor is electrically connected to an output of the first power supply, and an output of the first switching transistor is electrically connected to the input of the luminescence control circuit.

19. The display panel according to claim 15, wherein the second switch circuit comprises a second switching transistor and a second luminescence control signal line, a control terminal of the second switching transistor is electrically connected to an output of the second luminescence control signal line, an input of the second switching transistor is electrically connected to the output of the luminescence control circuit, and an output of the second switching transistor is electrically connected to the anode of the luminescent device.

20. The display panel according to claim 15, wherein the third switching circuit comprises a third switching transistor and a first scanning line, a control terminal of the third switching transistor is electrically connected to an output of the first scanning line, an input of the third switching transistor is electrically connected to the first terminal of the energy storage circuit, and an output of the third switching transistor is electrically connected to the input of the compensation circuit.
